(19) United States
(12) Patent Application Publication
(10) Pub. No.: US 2025/0386781 A1
(43) Pub. Date: Dec. 25, 2025

(54) ROOT FEEDER

(71) Applicant: Lawn and Garden, LLC, Coppell, TX (US)

(72) Inventor: Scott Ross, Paris, KY (US)

(73) Assignee: Lawn and Garden, LLC, Coppell, TX (US)

(21) Appl. No.: 19/245,306

(22) Filed: Jun. 21, 2025

Related U.S. Application Data
(60) Provisional application No. 63/663,683, filed on Jun. 24, 2024.

(51) Int. Cl. A01G 29/00; A01C 23/02

(52) U.S. Cl. CPC A01G 29/00; A01C 23/02

(57) ABSTRACT

An improved root feeder for dispensing a hydro-fertilizer solution or mixture is provided. The improvements include a simplified dome structure for closing a mixing bowl where the hydro-fertilizer solution or mixture is created and a locking trigger mechanism for more easily controlling water flow through the root feeder device. The improvements also comprise a number of additional features designed to make the device easier to use, such as rubberized and contoured gripping structures and multiple visible guides for users.

### PRIORITY CLAIM

This application claims priority to U.S. Provisional Application No. 63/663,683 filed on Jun. 24, 2024, which is hereby incorporated by reference.

### TECHNICAL FIELD OF THE INVENTION

The present invention is generally related to root feeder devices that can be used to deliver a hydro-fertilizer to plant root systems for fertilizing and feeding plants.

### BACKGROUND OF THE INVENTION

Use of dissolvable fertilizers or plant foods to create hydro-fertilizer solutions or mixtures that are applied directly to the root systems of plants and trees is a well-known technique for helping plants and trees to grow. Plants often require supplemental fertilizer and plant food in order to flourish and thrive, and this is especially true in less than ideal soils that lack an abundance of nutrients and minerals for healthy plant growth. Delivering hydro-fertilizer solutions or mixtures directly to the root system or the soil immediately surrounding the root system of a plant or tree results in the fertilizer not being lost on the surface around the plant or tree. This can be especially important with relatively impermeable soils, such as compacted or clay soils.

A number of prior root feeder devices have been devised that have been used to deliver fertilizer and plant food directly to the feeding systems of plants, namely, directly to plant roots or to the soil immediately surrounding and under the plant roots. For instance, U.S. Pat. No. 2,505,174 to Daniels entitled “Root Feeding Device” is one such device that was used in the past to deliver fertilizer and plant food directly to plant root systems located below the surface of the soil. Other related root feeder devices have been used over the years in order to deliver required nutrients to plant root systems in a similar manner. The commercial line of ROSS™ root feeders manufactured and distributed by Applicant and its predecessors over many decades have included many iterations of patented improvements to the basic root feeder device. For instance, prior improvements to the basic root feeder device have been iteratively disclosed in U.S. Pat. Nos. 3,618,539 and 4,705,218. U.S. Pat. No. 4,705,218 to Daniels shall be referred to herein as the “Daniels Patent.” Another related improvement to the root feeder device in the ROSS™ root feeder line of products was disclosed in U.S. Pat. No. 5,322,085 to Prothe entitled “Root Feeder.” U.S. Pat. No. 5,322,085 to Prothe shall be referred to herein as the “Prothe Patent.”

While the various improvements to the root feeder device provided by the above-listed patents were helpful in their day, with an aging population, some additional improvements to the root feeder device are desirable in order to make the root feeder easier to use for those who no longer have the same physical strength and manual dexterity that they did in their younger years.

### SUMMARY OF THE INVENTION

Accordingly, it is a purpose of the present invention to provide additional improvements to the previously-patented ROSS™ root feeder line of products in order to make the root feeders easier for use by persons who may not have the same physical strength and the same manual dexterity that they once had in the past when they were younger, but who still enjoy gardening and want to use the root feeder in connection with gardening or other activities involving growing plants and trees. The present invention is comprised of multiple improvements upon the preexisting commercial lines of ROSS™ root feeder devices, and it includes several specific improvements upon the Prothe Patent and the ancestral patents that pre-date the Prothe Patent. The present improved root feeder device that is hereby disclosed comprises many individual improvements to the root feeding device that were not previously disclosed in the Prothe Patent or its predecessors.

In certain embodiments, the presently disclosed improved root feeder device includes, without limitation, one or more of the following improvements: 1) a sturdy Zinc-coated steel main body; 2) addition of a top gripping system on the dual handle structure; 3) replacing the lever-operated, manual cut-off valve with a locking trigger mechanism; 4) wherein the locking trigger mechanism features its own additional contoured gripping structure; 5) a locking trigger guide to simplify operation of the locking trigger mechanism; 6) an improved dome lid design with only a quarter-thread and therefore only requiring a quarter-turn to attach or remove the dome lid from the mixing bowl instead of the prior screw-on dome that was fully-threaded and required multiple full rotations to attach or remove the dome; 7) a gripping structure at the top of the dome lid for easier handling and manipulation; 8) a dome guide for opening and closing the quarter-turn dome lid; 9) a more sturdy aluminum hose attachment coated in thermoplastic rubber for easier sealing connection; and 10) numbered depth markers on the feeder tube for clearly and easily determining the exact depth of insertion of the feeding tube into the soil where the plant roots are located. Many of these improvements listed above and further disclosed herein are specifically intended to help older users of the root feeder product who used the prior Prothe root feeder product, or its predecessors, in the past, but who may now lack the same physical strength and manual dexterity of their younger years.

An understanding of the operation, function, and components of the many embodiments of the improved root feeder device described herein may be facilitated by review of the appended drawings and review of the detailed description below.

### BRIEF DESCRIPTION OF THE DRAWINGS

The disclosed invention and its embodiments will be described with reference to the accompanying drawings, which show important sample embodiments, wherein:

FIG. 1 is an external front view of an embodiment of the improved root feeder device when fully assembled wherein the image of the feeder tube of the device is truncated to fit on the drawing page such that the total length of the feeder tube is not shown in relation to the device as a whole.

FIG. 2 is a side perspective view of the quarter-turn dome of the improved root feeder device.

FIG. 3 is top perspective view of the quarter-turn dome of the improved root feeder device.

FIG. 4 is a rotated perspective view of the feeder tube of the improved root feeder device.

FIG. 5 is a bottom perspective view of the locking trigger of the improved root feeder device.

FIG. 6 is a top perspective view of the locking trigger of the improved root feeder device.

FIG. 7 is perspective view of the trigger latch end cap of the improved root feeder device.

FIG. 8 is a perspective view of the trigger latch of the improved root feeder device wherein the trigger latch is rotated approximately 180° from its typical assembled orientation in order to better visualize the latch opening and latch recess.

FIG. 9 is an exploded perspective view of an embodiment of the root feeding device showing multiple internal components of the device in an exploded format.

### DETAILED DESCRIPTION OF THE DRAWINGS AND CERTAIN EMBODIMENTS

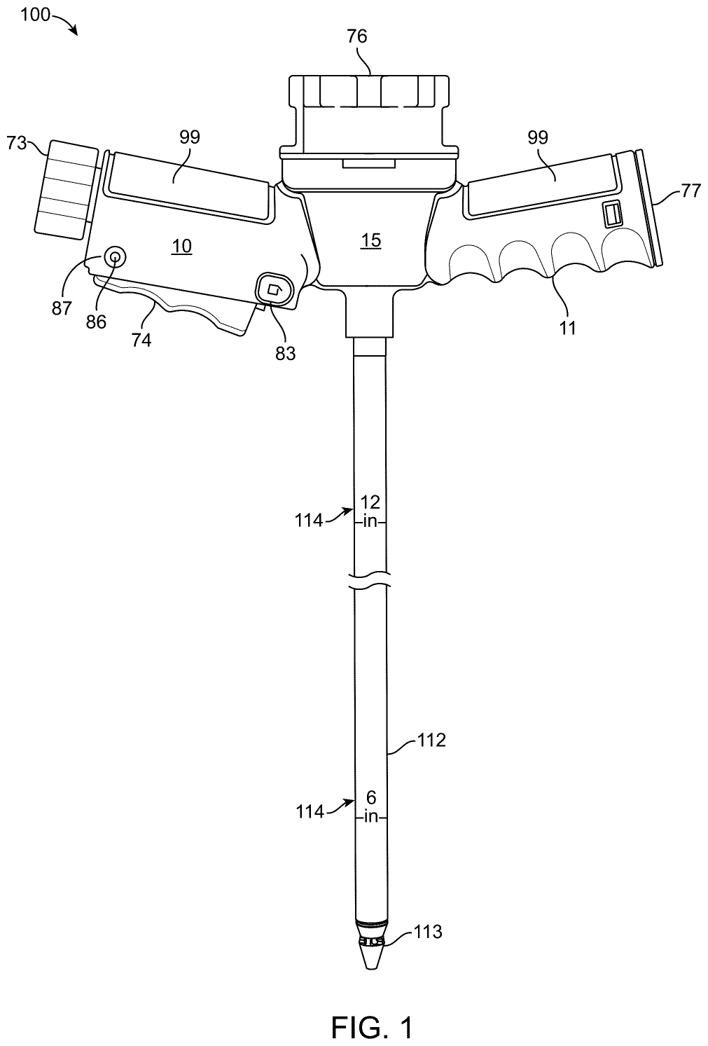

FIG. 1 is an image of the improved root feeder 100 showing one embodiment of the invention. As with the root feeder disclosed by the Prothe Patent, the improved root feeder 100 has a hollow main body featuring a mixing bowl 15 for receiving dissolvable fertilizer or plant food and at least one, but preferably two, handles that are similar to the dual handles of the Prothe Patent. As shown in FIG. 1, an embodiment of the improved root feeder device 100 that is hereby disclosed includes a quarter-turn dome 76 replacing the prior screw-on dome that was disclosed in the Prothe Patent and used in prior versions of the ROSS™ root feeder devices. The quarter-turn dome 76 may be used to threadingly engage or disengage with internal receiving screw threads (not illustrated) located inside the top cylindrical surface of the mixing bowl 15. The quarter-turn dome 76 is only partially threaded on its outside cylindrical surface so that it requires only a quarter of a turn in order to attach or remove the quarter-turn dome 76 from the top of the fertilizer mixing bowl 15 when loading fertilizer or plant food, whereas the prior designs of the ROSS™ root feeder devices, including the design disclosed by the Prothe Patent, required multiple turns of a fully-threaded screw-on dome to attach or remove the screw-on dome structure from the mixing bowl 15. A quarter turn of the present quarter-turn dome 76 is much more easily accomplished by users having older hands with decreased dexterity and possibly with arthritis when loading dissolvable fertilizer or plant food into the device.

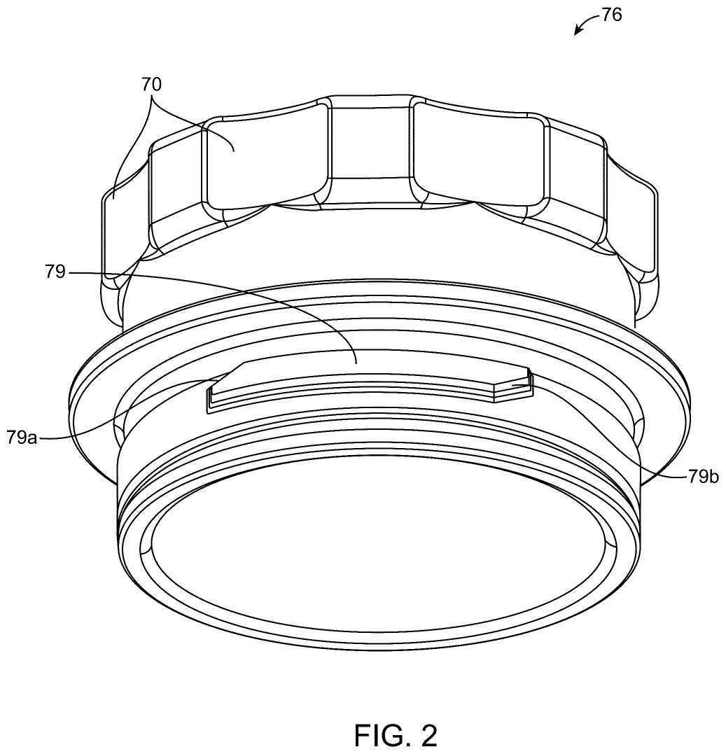

As best illustrated in FIG. 2, the quarter-turn dome 76 features a quarter screw thread 79 on its outside cylindrical surface with a screw thread downward chamfer 79a that allows for the quarter screw thread 79 to be threadingly engaged with the internal receiving screw threads located on the inside cylindrical surface of the mixing bowl 15 after the user has loaded dissolvable fertilizer or plant food material into the mixing bowl 15 and wishes to close the top of the mixing bowl 15 with the quarter-turn dome 76 preparatory to use of the root feeder device 100. The quarter screw thread 79 also features a screw thread upward chamfer 79b that allows for the quarter screw thread 79 to be threadingly disengaged from the internal receiving screw threads of the mixing bowl 15 when it becomes necessary to open the mixing bowl 15 in order to reload new fertilizer or plant food into the mixing bowl 15 preparatory to continued use of the device. As previously stated, the use of a quarter screw thread 79 is intended to facilitate opening and closing of the mixing bowl 15 by users with decreased manual dexterity, decreased grip strength, and possibly arthritis that makes manually opening and closing the mixing bowl 15 for loading fertilizer or plant food into the device more difficult to accomplish.

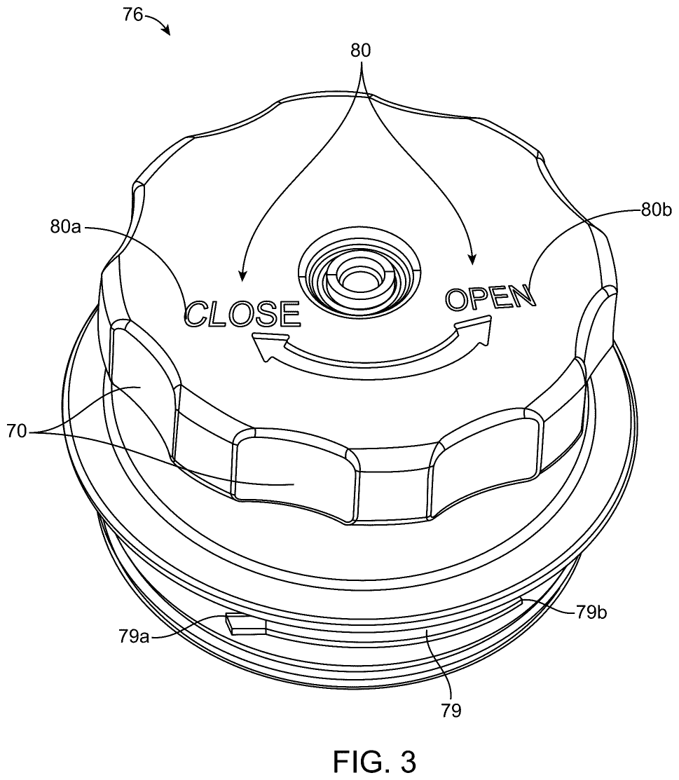

As shown in FIG. 2, in one embodiment of the improved root feeder device 100, the perimeter of the top of the quarter-turn dome 76 also features a dome gripping structure 70 that is comprised of simple knurling in the illustrated preferred embodiment, but could consist of any type of knurled, textured, or designed structure to provide a surface on the top perimeter of the quarter-turn dome 76 that is more readily grippable. The addition of a dome gripping structure 70 is intended to further facilitate an older user's ability to attach or remove the quarter-turn dome 76 with respect to the mixing bowl 15 of the device. As further shown in FIG. 3, one embodiment of the device will feature a dome guide 80 on the top surface of the quarter-turn dome 76 that provides visual guidance to a user regarding which direction the quarter-turn dome 76 must be rotated in order to open or close the mixing bowl 15. The dome guide 80 provides a close directional marking 80a and an open directional marking 80b that provide visual guidance to a user for using the quarter-turn dome 76 regarding how to open or close the mixing bowl 15. As can be understood, the close directional marking 80a corresponds with the screw thread downward chamfer 79a that allows for the quarter screw thread 79 to be threadingly engaged with the internal receiving screw threads of the mixing bowl 15 in order to close the dome on top of the bowl, while the open directional marking 80b corresponds with the screw thread upward chamfer 79b that allows for the quarter screw thread 79 to be threadingly disengaged from the internal receiving screw threads of the mixing bowl 15 in order to open the bowl for reloading it with fertilizer. In a preferred embodiment, the dome guide 80 also comprises a curved arrow symbol indicating rotation of the quarter-turn dome 76 in a respective direction is required to remove or attach the dome 76 to the mixing bowl 15. Taken together, the dome gripping structure 70 and the dome guide 80 facilitate the loading of dissolvable plant food or fertilizer into the mixing bowl 15 of the root feeder device 100 by older users.

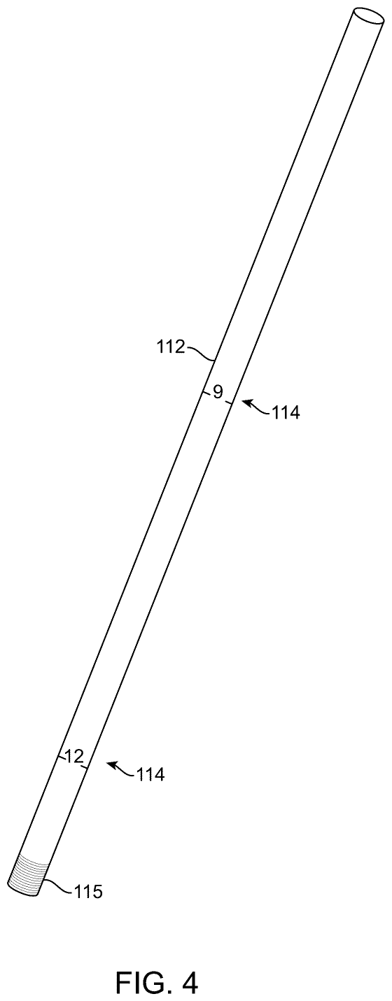

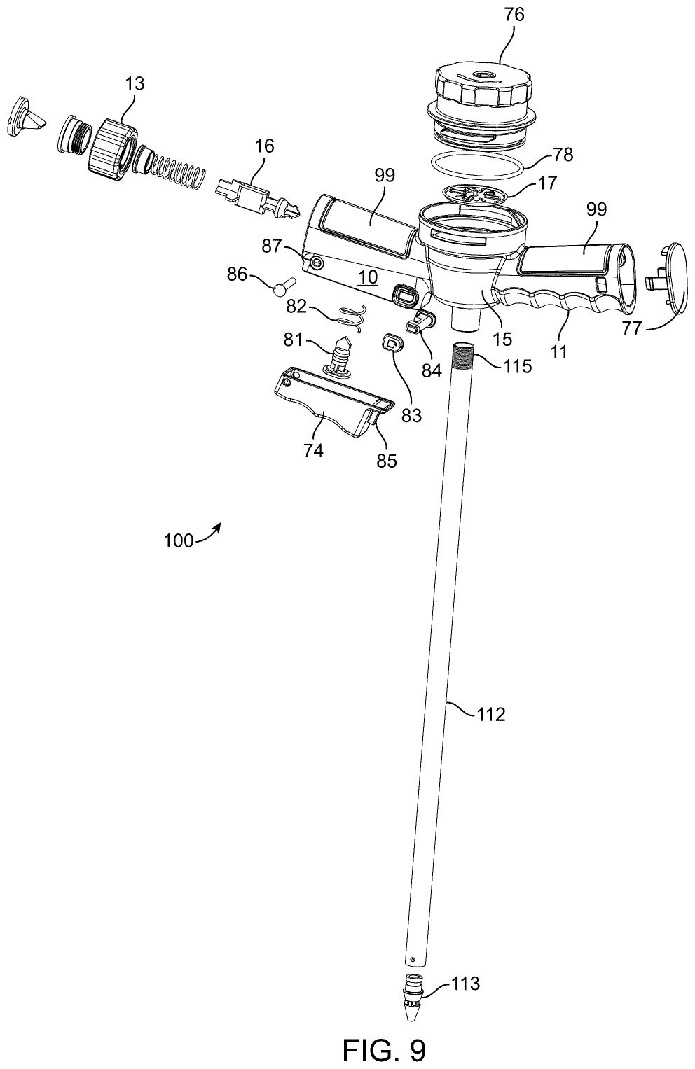

As also shown in FIG. 1, the improved root feeder device 100 has a hollow main body comprised of an intake handle 10, a stationary grip handle 11, and the mixing bowl 15, all of which are made of Zinc-coated, die-cast steel in a preferred embodiment. The root feeder 100 is further comprised of a feeder tube 112 that is similar in structure to the feeder tube of the Prothe Patent. The structures of the intake handle 10 and stationary grip handle 11 of the improved root feeder device 100 generally correspond to the structures of the dual handles described in the Prothe Patent in the sense that they may similarly be grasped by a user and used to push the device's feeder tube 112 into the soil to a desired depth, but the intake handle 10 and stationary grip handle 11 are distinct from the dual handles of Prothe in several respects, as described hereinbelow. The feeder tube 112 of the improved device 100 differs from the Prothe Patent in that it features multiple depth markings 114 that assist the user in inserting the feeder tube 112 into the soil to a desired depth. As shown in FIGS. 1 and 4, the depth markings 114 are Arabic numerals placed along the length of the feeder tube 112 that indicate specific lengths of the feeder tube 112 as measured vertically upward from a bottom spike 113 that is located at the very bottom of the feeder tube 112 and which is intended to be initially inserted into the soil. The depth markings 114 may be printed, etched, labeled, molded or otherwise similarly incorporated onto or into the feeder tube 112 so long as they are visible to a user for evaluating the depth of insertion of the tube 112 into the soil. In other words, the depth markings 114 on the feeder tube 112 are present so that a user may easily determine the depth of penetration of the feeder tube 112 into the soil by visualization of the depth markings 114, thereby eliminating any guesswork. As illustrated in FIGS. 1 and 9, the bottom spike 113 attached to the bottom of the feeder tube 112 for initial insertion into the ground prior to operation of the device has the same nozzle structure that was previously disclosed in the Daniels Patent.

In order to facilitate an older user's ability to grip and manipulate the root feeder device 100, including during placement into the ground prior to operation or during subsequent removal from the ground, both the intake handle 10 and the stationary grip handle 11 are each provided with rubberized grips 99 at their tops that allow for easier gripping and handling of the device 100 during its insertion into the soil or its later removal from the soil. This feature is an improvement over the prior dual handles shown in the Prothe Patent, and this improvement should benefit older users with hands that typically have less grip strength because it makes both handles 10, 11 easier to grip and hold the device 100 steady while inserting the device downwardly into the soil prior to operation of the device or when pulling upward on the device to remove it from the soil at a later time.

The root feeder device 100 also features a hose attachment coupling 73. During use of the device, water will flow into the main body of the device through a hose that is connected to the root feeder device 100 by the hose attachment coupling 73. Water flow through the hose attachment coupling 73 and into the main body of the device 100 will happen in a manner similar to that described by the Prothe Patent, but in a preferred embodiment of the present invention, the hose attachment coupling 73 is an aluminum nut that is coated with thermoplastic rubber to ensure a more watertight seal with an attached hose. This innovation of using an aluminum nut coated with thermoplastic rubber for the hose attachment coupling 73 allows for a more sturdy and durable connection to a hose, while also providing the ability to make a watertight seal with the connected hose.

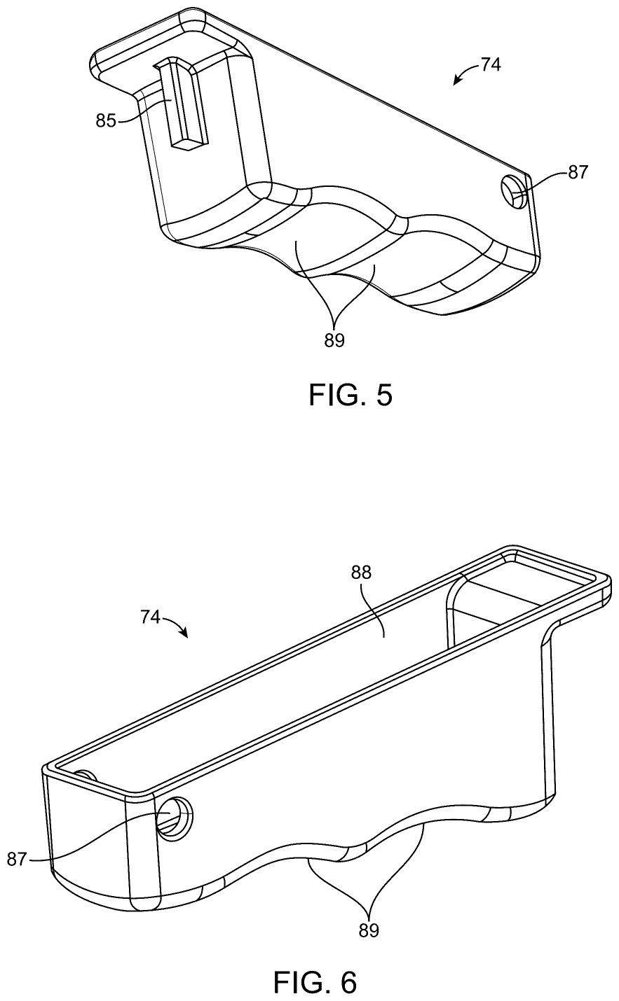

FIG. 1 further discloses a locking trigger 74 that serves to manually control water flow into the main body of the device 100. The locking trigger 74 is yet another improvement to the prior root feeder designs intended to facilitate use by older persons. As shown by the Prothe Patent, in prior root feeder designs, an internal manual cut-off valve was used to control the flow of water into the root feeder, and that manual cut-off valve was connected to an external on-off valve lever that could be used to selectively open or close the manual cut-off valve. The external on-off valve lever required a user to use a finger to push the external on-off valve lever up or down in order to turn-off or turn-on the water flow through the root feeder. As best illustrated in FIGS. 1, 5, 6, and 9, the locking trigger 74 of the present invention has a significantly different structure and operation that should be much easier for older hands to manipulate. The locking trigger 74 has both an external, contoured trigger grip 89 that is a contoured gripping structure shaped to be more easily grippable by a user, and an internal-facing trigger reservoir 88. The locking trigger 74 also features a trigger stop protrusion 85 that is located at the proximal end of the locking trigger 74 adjacent to the mixing bowl 15.

The locking trigger 74 is pivotably connected to the distal end of the intake handle 10 by virtue of a trigger pin 86 that passes through a trigger pin hole 87. The trigger pin hole 87 is a through-hole that passes through both the locking trigger 74 and the distal end of the intake handle 10 adjacent to the hose attachment coupling 73. The root feeder device 100 also features a piston spring 82 and a piston rod 81 with an angled face that are both internal to the trigger reservoir 88 and the intake handle 10. The piston spring 82 and piston rod 81 cooperate to provide downward pressure on the trigger reservoir 88 and the locking trigger 74 such that when a user is not applying upward force to the external-facing contoured trigger grip 89 of the locking trigger 74, the locking trigger 74 will be forced downward by the piston spring 82 and piston rod 81.

As shown in FIG. 9, the root feeder device 100 also features a guide valve 116 that is internal to, and seated within, the intake handle 10 prior to operation of the device. The guide valve 116 will control the flow of water through the device 100 by selectively stopping or starting the flow of water through the intake handle 10 and into the mixing bowl 15. In the fully assembled device 100, and prior to any application of upward force by the user on the contoured trigger grip 89 and locking trigger 74, the guide valve 116 is fully seated within the intake handle 10 such that even if an attached water hose is turned on and providing water under pressure at the point of the hose attachment coupling 73, no water will flow through the intake handle 10 and into the mixing bowl 15, and therefore the device 100 will not deliver any hydro-fertilizer solution to plant roots below because no water will flow through the device 100 while the guide valve 116 is seated within the intake handle 10. In order to operate the root feeder device 100 and start the flow of water through the device for delivery of hydro-fertilizer solution down the feeder tube 112 and out of the bottom spike 113, a user can apply upward force with their hand or with multiple fingers to the readily grippable, contoured trigger grip 89. Application of upward force on the contoured trigger grip 89 motivates the locking trigger 74 upwards, which will force the angled head of the piston rod 81 against an angled face of the guide valve 116. This action pushes the guide valve 116 away from its seat inside the intake handle 10 and allows for water to flow in through the hose attachment coupling 73, through the intake handle 10, through an orifice of the mixing bowl 15 into the mixing bowl 15 where it will mix with fertilizer or plant food, and then the resulting hydro-fertilizer solution or mixture will flow down the feeder tube 112 and out of the bottom spike 113.

As already stated above, the piston spring 82 and piston rod 81 cooperate to provide downward pressure on the trigger reservoir 88 and the locking trigger 74. As a result, when a user discontinues applying upward force to the external-facing contoured trigger grip 89 of the locking trigger 74, the locking trigger 74 will be forced downward by the piston spring 82 and piston rod 81, and the angled face of the piston rod 81 will be forced by the piston spring 82 away from the guide valve 116, and as a result the guide valve 116 will re-seat itself inside the intake handle 10 and the flow of water through the device will be stopped.

Another feature of the root feeder device 100 that constitutes an improvement over prior designs is the presence of a trigger latch 84 that may be used to hold the locking trigger 74 in place in an upward “locked” position such that the locking trigger 74 is held in place within the inside of the intake handle 10 without the continued application of manual upward force by a user's hand or fingers on the contoured trigger grip 89. The trigger latch 84 is best visualized in FIGS. 8 and 9. The trigger latch 84 is slidingly positioned within a horizontal through-hole that passes through the proximal end of the intake handle 10 adjacent to the mixing bowl 15. The trigger latch 84 features a latch body 97, a latch opening 96, and a latch recess 101. As shown, the latch opening 96 is an open notch that passes completely vertically through part of the latch body 97, while the latch recess 101 is an area of the latch body 97 adjacent to the latch opening 96 wherein the latch body 97 has an offset surface but does not constitute a completely open notch through the latch body 97. The trigger latch 84 also features a latch closed symbol 94 that is located on the end of the trigger latch 84 furthest away from the latch opening 96. When the root feeder device 100 is fully assembled, a trigger latch end cap 83 is attached to the end of the trigger latch 84 that is closest to the latch opening 96. The trigger latch end cap 83 features a latch open symbol 93. The latch open symbol 93 and the latch closed symbol 94 may be printed, etched, molded, or otherwise made a part of the respective trigger latch end cap 83 and trigger latch 84 so long as they are visible to a user at the respective ends of the horizontal through-hole that passes through the proximal end of the intake handle 10 adjacent to the mixing bowl 15.

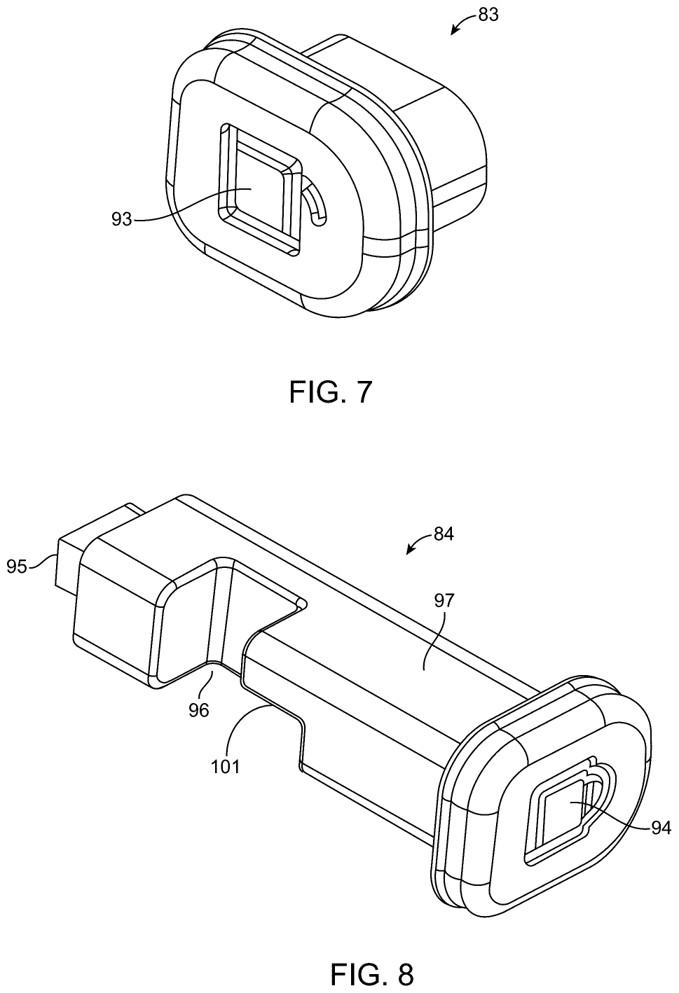

As can best be appreciated from reviewing FIGS. 1 and 5-9 collectively, during operation of the root feeder device 100, the user starts the flow of water through the device by pulling upwards on the contoured trigger grip 89 of the locking trigger 74 so that the locking trigger 74 is pivoted upward to a position at the inside portion of the intake handle 10. This pulling upwards of the locking trigger 74 forces the piston rod 81 upward into contact with the guide valve 116 such that the guide valve 116 is unseated and water flows through the device 100 in the manner described above. Pulling upward on the locking trigger 74 may occur at a time when the trigger stop protrusion 85 is seated within the perimeter of the latch opening 96. As may be further appreciated, if the user desires to have the water continue to flow through the device 100 for a longer period of time, but does not wish to continue to manually hold the locking trigger 74 in an upward position within the intake handle 10 by continued application of force from the user's hand or fingers pulling upwardly on the contoured trigger grip 89, the user can temporarily lock the locking trigger 74 in the upward position within the intake handle 10 for as long as may be desired by the user pushing inward on the trigger latch 84 on its end where the latch closed symbol 94 is located and thereby sliding the trigger latch 84 into a position where the surface of the latch recess 101 will come into supporting contact with the trigger stop protrusion 85. Thereafter, the user may cease the application of force involving the user's hand or fingers pulling upwardly on the contoured trigger grip 89 of the locking trigger 74, but the locking trigger 74 and piston rod 81 will not be pushed downward by any downward force of the piston spring 82 because the locking trigger 74 will be held in place as a result of the supporting contact between the trigger stop protrusion 85 and the underlying supporting surface of the latch recess 101. In this manner, the trigger latch 84 may be used to continue operation of the device 100 without the user continually pulling upwardly on the contoured trigger grip 89, and the user may walk away and allow the device 100 to continue to feed hydro-fertilizer solution to the roots of the plant or tree.

As can further be understood from reviewing the drawings, the user can thereafter stop the water flow through the root feeder device 100 by pushing inwardly on the trigger latch 84 on its end where the latch open symbol 93 is located and thereby sliding the trigger latch 84 into a position where the surface of the latch recess 101 is no longer in supporting contact under the trigger stop protrusion 85. This will allow the downward force of the piston spring 82 to push the piston rod 81 down and will force the locking trigger 74 to pivot downward since the trigger stop protrusion 85 will once again be seated within the perimeter of the latch opening 96 and will no longer be supported from below by the surface of the latch recess 101. In this position, the locking trigger 74 and piston rod 81 will be capable of either upward or downward movement, but they will be held in the downward “unlocked” position by downward force of the piston spring 82 such that the guide valve 116 is re-seated within the intake handle 10 and no water is flowing through the device unless the user should choose to restart the water flow through the device by again applying manual upward force on the contoured trigger grip 89 to push the locking trigger 74 and piston rod 81 upward. During the entire operations of the trigger latch 84 for the purposes of reversibly locking or unlocking the locking trigger 74, the user is aided by the latch open symbol 93 and latch close symbol 94 that cooperate to serve as a visual guide for the locking or unlocking of the locking trigger 74.

The embodiments and other features, aspects, and advantages of the present invention may be best understood and appreciated with reference to the drawings, descriptions, and claims. Where used in the various figures of the drawings, the same numerals designate the same or similar parts. Furthermore, to the extent that the terms “top”, “bottom”, “down”, “downward”, “up”, :upward”, “front”, “back”, “surface”, “perimeter”, “proximal”, “distal”, “end”, “ends”, “side”, “sides”, “edge”, “edges”, “horizontal”, “lateral”, “vertical”, “perpendicular”, “parallel”, and similar terms have been used in the description of the embodiments hereby provided, it should be understood that, unless otherwise specifically stated or otherwise made specifically clear by context, these terms have reference only to the structures shown in the drawings as they would appear to a person viewing the drawings, and such terms are utilized in order to facilitate describing the invention and in order to facilitate a better understanding of the invention.

It should also be appreciated that the terms “pulling” as used in the above description and appended claims should be viewed as synonymous with the term “pushing” and like terms in the sense that both indicate the application of force or directional pressure to a structure or component. Furthermore, the term “dome” should be viewed as synonymous with the terms “lid”, “cap”, and like terms in the sense that they serve as a structure for closing or containing materials within a holding structure such as the mixing bowl of the present invention.

Although the invention has been described with reference to specific embodiments, this description is not meant to be construed in a limiting sense. Various modifications of the disclosed embodiments, as well as alternative embodiments of the invention, will be apparent to persons skilled in the art upon reference to the description of the invention that is provided in this specification. It is, therefore, contemplated that the appended claims will cover such modifications and variations that fall within the scope of the invention.

What I claim is:

1. An improved root feeder device that when connected to an external water supply can be used for delivering hydro-fertilizer solutions or mixtures to plant root systems comprising:
a main body comprised of at least one handle and a mixing bowl;
a hose attachment coupling for connecting the main body to a water supply;
an elongated feeder tube for delivery of hydro-fertilizer solution or mixture into soil below ground level;
a trigger mechanism that may be manually pulled in order to allow the flow of water through the root feeder device.

2. The improved root feeder of claim 1, further comprising a latch mechanism that may be pushed in a first direction in order to engage and hold the trigger mechanism in a locked position such that water will continue flowing through the root feeder device even after manual pulling on the trigger mechanism is discontinued.

3. The improved root feeder of claim 2 wherein the latch mechanism may be pushed in a second direction that disengages the latch mechanism from the trigger mechanism thereby unlocking the trigger mechanism and discontinuing the flow of water through the root feeder device in the absence of any manual pulling on the trigger mechanism.

4. The improved root feeder of claim 2, further comprising a visible marking that indicates where to push the latch mechanism in order to engage and hold the trigger mechanism.

5. The improved root feeder of claim 3, further comprising a visible marking that indicates where to push the latch mechanism in order to disengage and unlock the trigger mechanism.

6. The improved root feeder of claim 1, wherein the trigger mechanism is comprised of a contoured gripping structure.

7. The improved root feeder of claim 1, further comprising a dome that may be used to open or close the mixing bowl.

8. The improved root feeder of claim 7, further comprising:
a first at least partial screw thread provided on the internal cylindrical surface of the mixing bowl;
a second at least partial screw thread provided on the external cylindrical surface of the dome;
wherein closing the mixing bowl with the dome involves threadingly engaging the first at least partial screw thread of the mixing bowl with the second at least partial screw thread of the dome and rotating the dome in a first direction; and
wherein the closing of the mixing bowl may be reversed in order to open the mixing bowl by rotating the dome in a second direction that is the opposite of the first direction.

9. The improved root feeder of claim 8 wherein the rotation of the dome in order to open or close the mixing bowl is less than a full rotation of the dome.

10. The improved root feeder of claim 9 further comprising:
a gripping structure provided on the outside perimeter of the dome;
visible markings on the top of the dome indicating the respective directions in which the dome must be rotated in order to open or close the mixing bowl using the dome.

11. The improved root feeder of claim 1, wherein the at least one handle is provided with a rubberized grip.

12. The improved root feeder of claim 1, wherein the elongated feeder tube is marked with visible depth markings that may be used to determine the depth to which the feeder tube is inserted into the ground during use.

13. An improved root feeder device that when connected to an external water supply can be used for delivering hydro-fertilizer solutions or mixtures to plant root systems comprising:
a main body comprised of at least one handle and a mixing bowl;
a hose attachment coupling for connecting the main body to a water supply;
an elongated feeder tube for delivery of hydro-fertilizer solution or mixture into soil below ground level; and
a dome that may be used to selectively open or close the mixing bowl by means of a partial screw thread provided on the outside cylindrical surface of the dome.

14. The improved root feeder of claim 13, wherein opening or closing the mixing bowl with the dome requires less than a full rotation of the dome.

15. The improved root feeder of claim 13, wherein the dome further comprises a gripping structure that may be used to grip and rotate the dome when opening or closing the mixing bowl using the dome.

16. The improved root feeder of claim 13, further comprising a marking on the top of the dome indicating which directions the dome must be rotated in order to open or close the mixing bowl using the dome.

17. The improved root feeder of claim 13, further comprising a trigger mechanism that may be manually pulled in order to allow the flow of water through the root feeder device.

18. The improved root feeder of claim 17, further comprising a latch mechanism that may be pushed in a first direction in order to engage and hold the trigger mechanism in a locked position such that water will continue flowing through the root feeder device even after manual pulling on the trigger mechanism is discontinued.

19. The improved root feeder of claim 18, wherein the at least one handle is provided with a rubberized grip.

20. An improved root feeder device that when connected to an external water supply can be used for delivering hydro-fertilizer solutions or mixtures to plant root systems comprising:
a main body comprised of at least one handle and a mixing bowl;
a hose attachment coupling for connecting the main body to a water supply;
an elongated feeder tube for delivery of hydro-fertilizer solution or mixture into soil below ground level;
a trigger mechanism that may be manually pulled in order to allow the flow of water through the root feeder device;
a latch mechanism that may be pushed in a first direction in order to engage and hold the trigger mechanism in a locked position such that water will continue flowing through the root feeder device even after manual pulling on the trigger mechanism is discontinued;
a dome that may be used to selectively open or close the mixing bowl by means of a partial screw thread provided on the outside cylindrical surface of the dome; and
wherein opening or closing the mixing bowl with the dome requires less than a full rotation of the dome.
